(19) United States
(12) Patent Application Publication
(10) Pub. No.: US 2006/0168566 A1
(43) Pub. Date: Jul. 27, 2006

(54) Pattern matching documentation

(75) Inventor: Sean P. Grimaldi, Bellevue, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/042,664

(22) Filed: Jan. 25, 2005

(51) Int. Cl. G06F 9/44

(52) U.S. Cl. 717/123

(57) ABSTRACT

Existing documentation prepared for a pattern displayed in a first source is applied to a similar pattern displayed in a second source. The first source may be source code in a first programming language and the second source may be source code in a second language. Alternatively, patterns may be found in object code, intermediate code, executable code, hardware, or user actions.

### FIELD OF THE INVENTION

The invention relates to generating documentation and in particular to re-using portions of documentation that apply to patterns.

### BACKGROUND OF THE INVENTION

Documentation is written or displayable information associated with products, including machinery, electronic devices, vehicles, computer hardware, computer software and so on. Documentation may provide a technical description of the product, provided as an aid in evaluation, installation, support, maintenance or future development. This type of documentation typically includes information such as when, where, and by whom the hardware was manufactured or the software was written and a general description of the purpose and features of the product. Software documentation may include recommended input, output, and storage methods; and a detailed, although not necessarily comprehensive, description of the way the software functions. It may also include programming code, diagrams, and flow charts; and details of software testing, including sets of test data with expected results.

Documentation may also explain how to use the product. This type of documentation typically includes an explanation of the purpose of the product; instructions for running and using the product and so in. In the case of computer software, documentation may also include instructions for preparing any necessary input data; instructions for requesting and interpreting output data; and explanations of any error messages that the program may produce.

Computer software is especially difficult to document because it can evolve very quickly. Documentation writers typically document the software during the (often-brief) period of time between completion of the software and its release to customers, making accurate, thorough documentation difficult. Because of these difficulties, sometimes documentation for critical aspects of the software including important aspects such as security and error handling is omitted or inaccurate. Inaccurate or misleading information may also be published because the code has changed since the feature was documented. Missing, incomplete or inaccurate information can undermine customer trust, slow adoption of new software and reduce security.

It would be helpful if existing documentation could be re-used, when applicable. Specifically, although the concepts described herein also apply to other types of documentation they are especially helpful for software documentation.

### SUMMARY OF THE INVENTION

Existing documentation that applies to a particular pattern found in one source or usage can be applied to the pattern discovered in a second source or usage. Such a pattern may be found in software, in hardware or in a series of user actions taken to invoke a particular feature or aspect thereof. Existing documentation in whole or in part can be re-used, applying the documentation produced for the pattern in the first source to the pattern in the second source. Patterns can include patterns in software source code presented in various programming languages, object code, intermediate code and executable code. Patterns can also include user patterns and hardware patterns. Patterns can exist at a very detailed level or at a more global level as well as at all points between. Patterns may be discovered by any means, including programmatic analysis or analysis by humans, by leveraging inherent or invoked program language features and so on.

Patterns and associated documentation may be stored in a data store, such as a data base or file system, so that it can be easily accessed for application to other sources.

### BRIEF DESCRIPTION OF THE DRAWINGS

The foregoing summary, as well as the following detailed description of illustrative embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram showing an exemplary computing environment in which aspects of the invention may be implemented;

FIG. 2 is a block diagram of an exemplary system for re-using existing documentation in accordance with one embodiment of the invention;

FIGS. 3a-3c are block diagrams of exemplary systems for re-using documentation in accordance with embodiments of the invention;

FIG. 4 is a flow diagram of a method for re-using existing documentation in accordance with one embodiment of the invention;

FIGS. 5a and 5b illustrate signatures of disassembled methods in two programming languages; and

FIGS. 6a and 6b illustrate intermediate code generated by source code in two programming languages.

### DETAILED DESCRIPTION OF ILLUSTRATIVE EMBODIMENTS

Overview

Many software languages use the same software constructs, enabling existing documentation produced for one software language construct to be applied to the same construct implemented in another software language. For example, a construct that iterates through a list of items or objects in an array exists for many software programming languages including procedural languages, object oriented languages, hybrid languages and so on, including but not limited to Ada, ALGOL, APL, AWK, BASIC, C, C++, C# Cobol, Delphi, Fortran, Java, JavaScrpt, J#, LISP, Pascal, Perl, Prolog, Python, Ruby, SAS, Smalltalk, SQL, Visual Basic and many others. Thus, existing software documentation for enumerating through items or objects in a list in a program in one language can be used to document or at least help in documenting the same construct in another program written in a second language. Even if the construct in the first language is not identical to the that in the second language, existing documentation for the construct in the first language should prove helpful in the preparation of dcoumentaiton for the construct in the second language.

Similarly, the series of actions a user takes to activate or use a feature may be repeated among a number of features within a software application or operating system, enabling existing user documentation prepared for a feature in one application to be applied to another feature in the same application or another application. For example, user patterns associated with opening or saving a file may be identical in several applications. Thus, existing user documentation for opening or saving a file in the first application can be used to document the same action or actions in a second application or in a second feature of the same application.

Exemplary Computing Environment

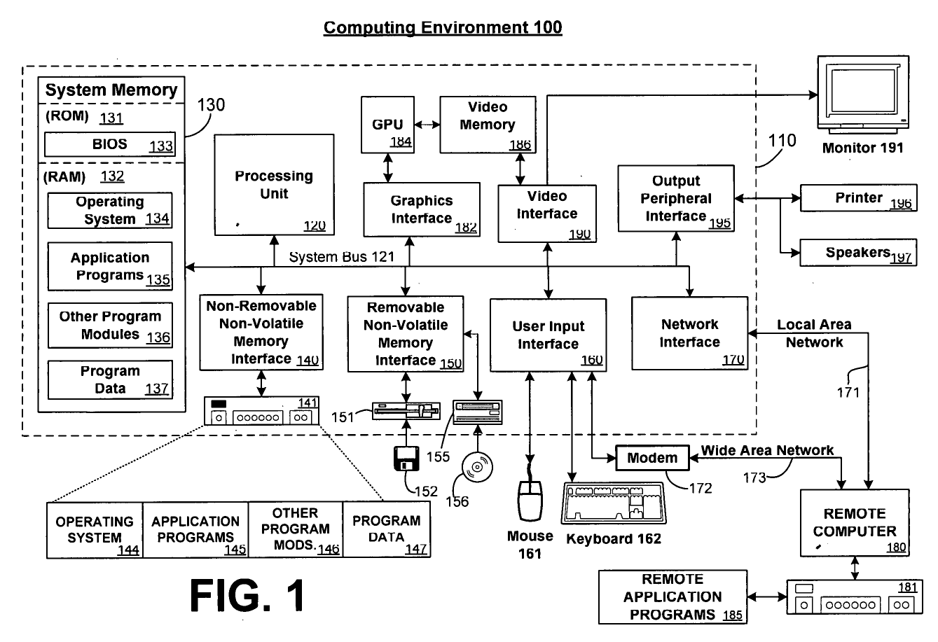

FIG. 1 and the following discussion are intended to provide a brief general description of a suitable computing environment in which the invention may be implemented. It should be understood, however, that handheld, portable, and other computing devices of all kinds are contemplated for use in connection with the present invention. While a general purpose computer is described below, this is but one example, and the present invention requires only a thin client having network server interoperability and interaction. Thus, the present invention may be implemented in an environment of networked hosted services in which very little or minimal client resources are implicated, e.g., a networked environment in which the client device serves merely as a browser or. interface to the World Wide Web.

Although not required, the invention can be implemented via an application programming interface (API), for use by a developer, and/or included within the network browsing software which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use. or functionality of the invention. Neither should the computing environment 100 be interpreted as having any dependency or requirement relating to any one or combination of components illustrated in the exemplary operating environment 100.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186. GPUs 184, however, are but one example of a coprocessor and thus a variety of coprocessing devices may be included in computer 110. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

Applying Existing Documentation to Product with Similar Pattern

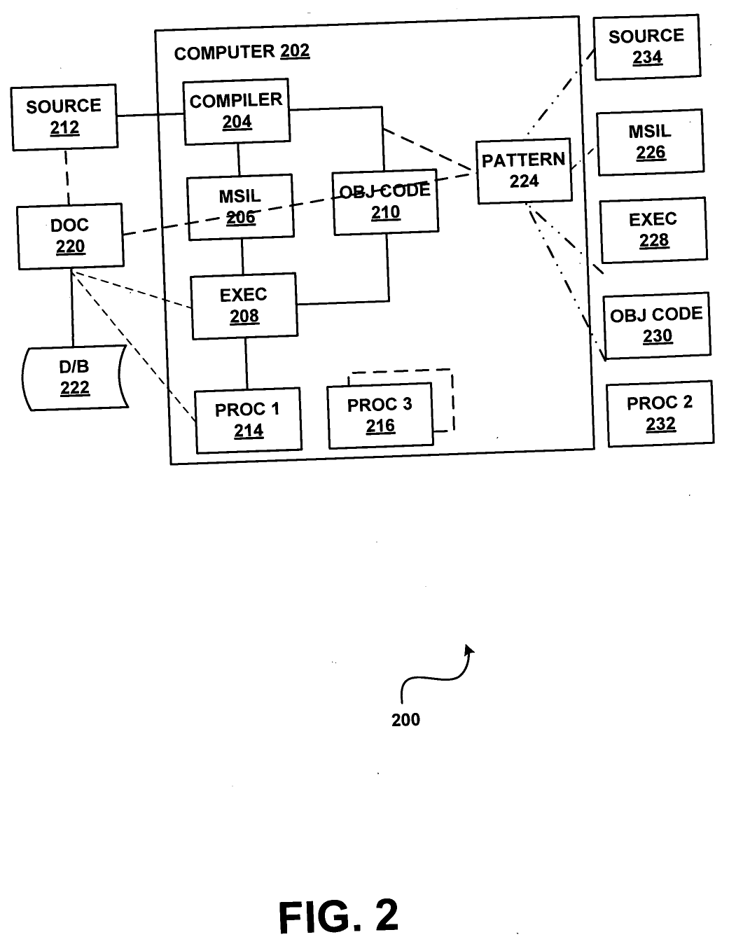

FIG. 2 is a block diagram of a system for applying existing documentation prepared for a pattern in a first software source or usage to software or usage with a similar pattern in a second source, in accordance with one embodiment of the invention. In FIG. 2 such a system (e.g., system 200 or portions thereof) may reside on one or more computers as represented by computer 202. Computer 202 may be a computer such as computer 110 described with respect to FIG. 1.

System 200 may include one or more of: a computer 202, a compiler 204 that receives source code 212 and generates therefrom intermediate language (e.g., Microsoft Intermediate Language or MSIL) 206, or object code 210. From the MSIL code 206 or object code 210, executable code 208 may be generated. The source code 212 may be in any programming language, including but not limited to: Ada, ALGOL, APL, AWK, BASIC, C, C+, C++, C# Cobol, Delphi, Fortran, Java, JavaScrpt, J#, LISP, Pascal, Perl, Prolog, Python, Ruby, SAS, Smalltalk, SQL, Visual Basic and so on.

Executable code 208 may be used to instantiate a process such as process 1 214. Documentation 220 may have been created to document code (e.g., source code 212, object code 210, intermediate language code 206, executable code 208), or to document software as it executes (represented in FIG. 2 by process 1 214) or user actions performed when initiating or running the software or, in general, any pattern, (represented in FIG. 2 as pattern 224), wherever found, whether in software, processes, or user actions. Documentation 220 may be stored in database 222 and may include an identification of the pattern 224 documented. Documentation 220 may be generated by a human or programmatically, or by leveraging existing features of the programming language in which the code is written. Documentation may include text, program code or code snippets, graphs or other illustrations and so on.

Pattern 224 may also be associated with source code 234, object code 230, intermediate language code 226 or executable code 228. Once it is determined that pattern 224 applies to the source code 234, object code 230, intermediate language code 226 or executable code 228, documentation 220 may be applied to source code 234, object code 230, intermediate language code 226 or executable code 228. Source code 234, object code 230, intermediate language code 226 and/or executable code 228 may reside on the same or on a different computer than the computer on which source code 212, object code 210, intermediate language code 206, executable code 208 and/or process 1 214 reside.

Pattern 224 may also be associated with process 2 232 or with hardware components associated with process 2 232. Once it is determined that pattern 224 applies to process 2 232, documentation 220 may be applied to process 2 232. Process 1 214 and process 2 232 may communicate via particular hardware components. Pattern 224 may be associated with the way in which process 1 214 and process 2 232 communicate. For example, both process 1 214 and process 2 232 may open a particular port, move one or more packets of information to the port and close the port. Similarly, a pattern such as pattern 224 may be associated with processes running on the same computer, such as process 1 214 and process 2 216.

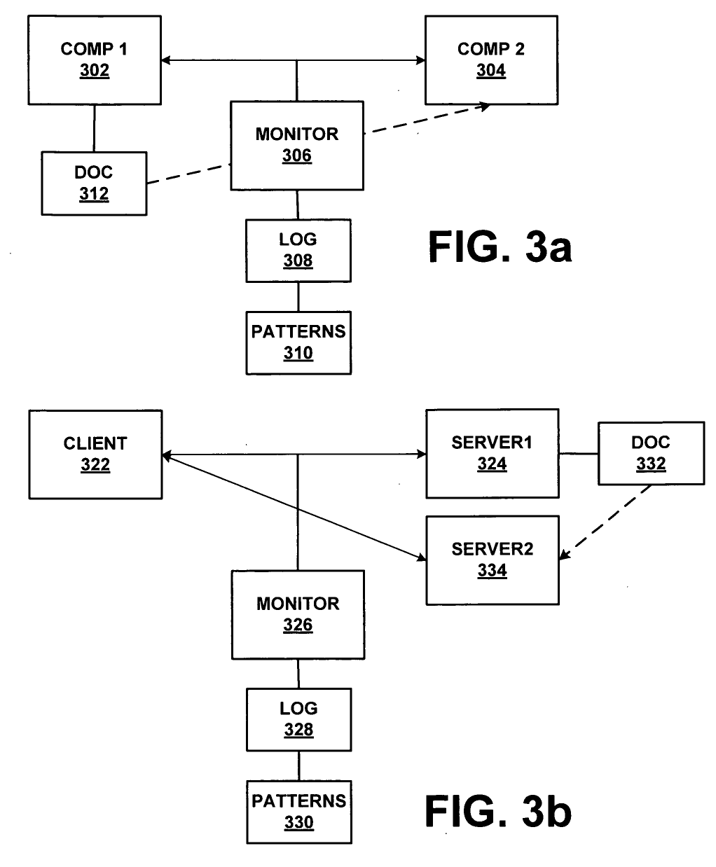

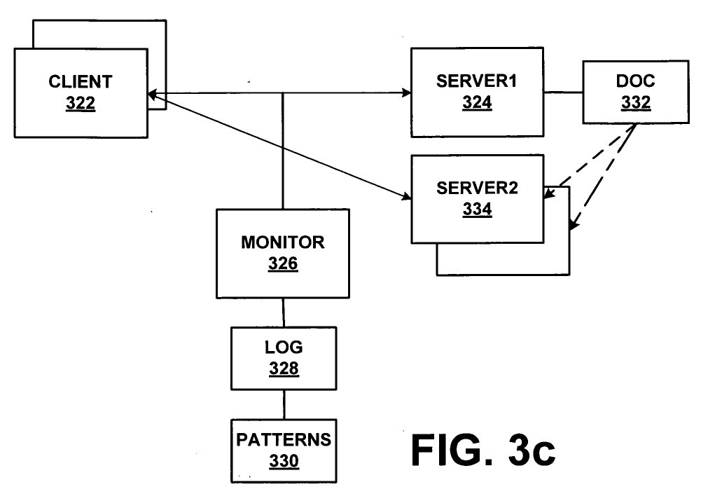

FIGS. 3a-3c illustrate various implementations of a system in accordance with the invention. In FIG. 3a, messages may be sent between computer 1 302 and computer 2 304. A monitor 306 may intercept messages between computer 1 302 and computer 2 304 and capture certain information to a log 308. As the log 308 is generated, or after some period of log generation, the data captured in the log 308 may be analyzed to determine patterns 310. For example, the patterns of information sent from computer 1 302 to computer 2 304 may be compared to the patterns of information sent from computer 2 304 to computer 1 302, and thus documentation (e.g., doc 312) developed for computer 1 302 may be applied to computer 2 304.

FIG. 3b illustrates a client 322 which communicates with server 1 324 and server 2 334. A monitor 326 may intercept messages between client 322 and server 1 324 and vice versa and may also intercept messages between client 322 and server 2 334 and vice versa, capturing information to log 328. As or after the log 328 is generated, the data captured in the log 328 may be analyzed to determine patterns 330. For example, the patterns of information sent to and from client 322 from and to server 1 324 may be compared to the patterns of information sent to and from client 322 from and to server 2 334, and thus documentation 332 developed for server 1 324 may be applied to server 2 334.

FIG. 3c illustrates a number of clients 322, etc. communicating with a number of servers 324, 326, etc. A monitor 326 may intercept messages between clients 322, etc. and server 1 324, server 2 334, etc. and vice versa, capturing information to log 328. As or after the log 328 is generated, the data captured in the log 328 may be analyzed to determine patterns 330. For example, the patterns of information sent to and from clients 322, etc. from and to server 1 324 may be compared to the patterns of information sent to and from client 322 etc. from and to server 2 334, etc. and thus documentation 332 developed for server 1 324 may be applied to server 2 334, etc. It will be apparent that although a single monitor is depicted, and a single log and so on, the invention as contemplated is not so limited. Any number of monitors and logs may be used and generated.

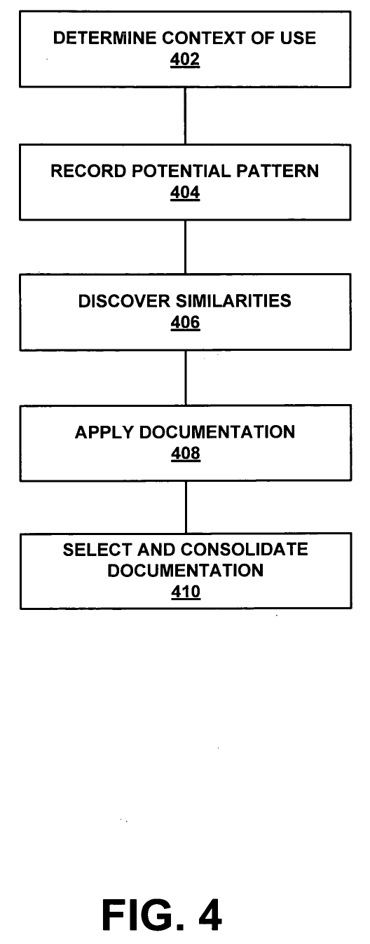

FIG. 4 is a flow diagram of an exemplary method for applying existing documentation for one source to another source in accordance with some embodiments of the invention. At 402 a context for the pattern discovery is determined. For example, the pattern may encompass all source programs on a particular computer, all users at a company, all the user actions taken to embed an object into a document by a particular department, a particular programming construct in a particular programming language or any suitable context.

At 404 the data is captured. The data may comprise patterns of binary code generated by a compiler from source code, series of actions taken by users, similarities in messages sent between computers or any suitable data. The data may be stored in a log, a database, file or any data store.

At 406 the captured data is analyzed. Patterns within the captured data are determined. Patterns may be determined by self-documenting features of the programming language (such as, for example, reflection techniques or other self-documenting features of programming languages, developer-invoked descriptions such as assignment of attributes or properties to members or types, comments and so on). Patterns may also be discovered by programatic analysis, analysis by humans, or by any suitable method. At 408, existing documentation associated with the source for which the documentation was prepared is applied to the source of the captured data for which documentation is currently not available. This documentation may be combined with new documentation written by a human, or documentation generated by software, etc. to generate a consolidated set of documentation (410).

Examples of patterns that may be found in software include the following:

many .NET languages implement the IEnumerable interface, which can be discovered by reflection software so that the documentation prepared for one .NET language for the IEnumerable interface may be re-used for all the other .NET languages

an iterator pattern is a programming construct that provides a way to access the elements of a collection sequentially. For example, the following represents code that is typical of the iterator pattern in Visual Basic:

```
Imports System
Imports System.Collections ‘ ArrayList
Namespace ConsoleApplication2
  Class Class1
    ‘ The main entry point for the application.
    <STAThread( )>_{—}
    Shared Sub Main( )
      Dim bunch As Bunch = New Bunch
      bunch(0) = “thing 1”
      bunch(1) = “thing 2”
      bunch(2) = “thing 3”
      Dim iterator As AnIterator = New AnIterator(bunch)
      Dim thing As Object = iterator.Beginning( )
      While (thing <> Nothing)
        Console.WriteLine(thing)
        thing = iterator.NextThing( )
      End While
      ‘ output is:
      ‘ thing 1
      ‘ thing 2
      ‘ thing 3
      Console.ReadLine( )
    End Sub
  End Class
  ‘ Iterator
  Class Bunch
    Dim things As ArrayList = New ArrayList
    Public Function CreateIterator( ) As AnIterator
      Return New AnIterator(Me)
    End Function
    Public ReadOnly Property Count( ) As Integer
      Get
        Return things.Count
      End Get
    End Property
    Default Public Property Item(ByVal index As Integer) As Object
      Get
        Return things(index)
      End Get
      Set(ByVal Value As Object)
        things.Insert(index, Value)
      End Set
    End Property
  End Class
  Class AnIterator
    Dim bunch As bunch
    Dim current As Integer = 0
    Public Sub New(ByVal bunch As bunch)
      Me.bunch = bunch
    End Sub
    Public Function Beginning( ) As Object
      Return bunch(0)
    End Function
    Public Function AtEnd( ) As Boolean
      If current >= bunch.Count Then
        Return True
      Else
        Return False
      End If
    End Function
    Public Function NextThing( ) As Object
      If (current < bunch.Count − 1) Then
        current = current + 1
        Return bunch(current)
      Else
        Return Nothing
      End If
    End Function
    Public Function CurrentThing( ) As Object
      Return bunch(current)
    End Function
  End Class
End Namespace
```

While the following is the same construct in C#:

```
using System;
using System.Collections;// ArrayList
namespace ConsoleApplication2
{
    /// <summary>
    /// Summary description for Class1.
    /// </summary>
    class Class1
    {
        /// <summary>
        /// The main entry point for the application.
        /// </summary>
        [STAThread]
        static void Main(string[ ] args)
        {
            Bunch bunch=new Bunch( );
            bunch[0]=“thing 1”;
            bunch[1]=“thing 2”;
            bunch[2]=“thing 3”;
            AnIterator iterator=new AnIterator(bunch);
            object thing=iterator.Beginning( );
            while(thing!=null)
            {
                Console.WriteLine(thing);
                thing=iterator.NextThing( );
            }
            /*output is:
            thing 1
            thing 2
            thing 3
            */
            Console.ReadLine( );
        }
    }
    // Iterator
    class Bunch
    {
        ArrayList things=new ArrayList( );
        public AnIterator CreateIterator( )
        {
            return new AnIterator(this);
        }
        public int Count
        {
            get
            {
                return things.Count;
            }
        }
        public object this[int index]
        {
            get
            {
                return things[index];
            }
            set
            {
                things.Insert(index, value);
            }
        }
    }
    class AnIterator
    {
    Bunch bunch;
    int current=0;
    public AnIterator(Bunch bunch)
    {
        this.bunch=bunch;
    }
    public object Beginning( )
    {
        return bunch[0];
    }
    public bool AtEnd( )
    {
        return current>= bunch.Count?true:false ;
    }
    public object NextThing( )
    {
        if(current<bunch.Count−1)
        {
            return bunch[++current];
        }
        else
        {
            return null;
        }
    }
    public object CurrentThing( )
    {
        return bunch[current];
    }
}
```

The similarities in the source code are apparent.

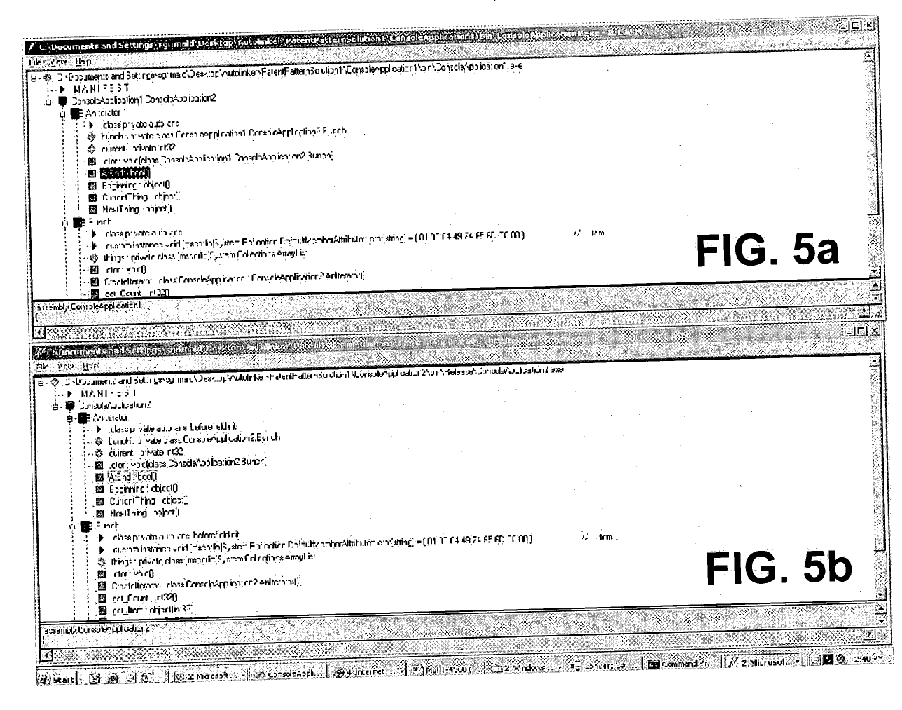

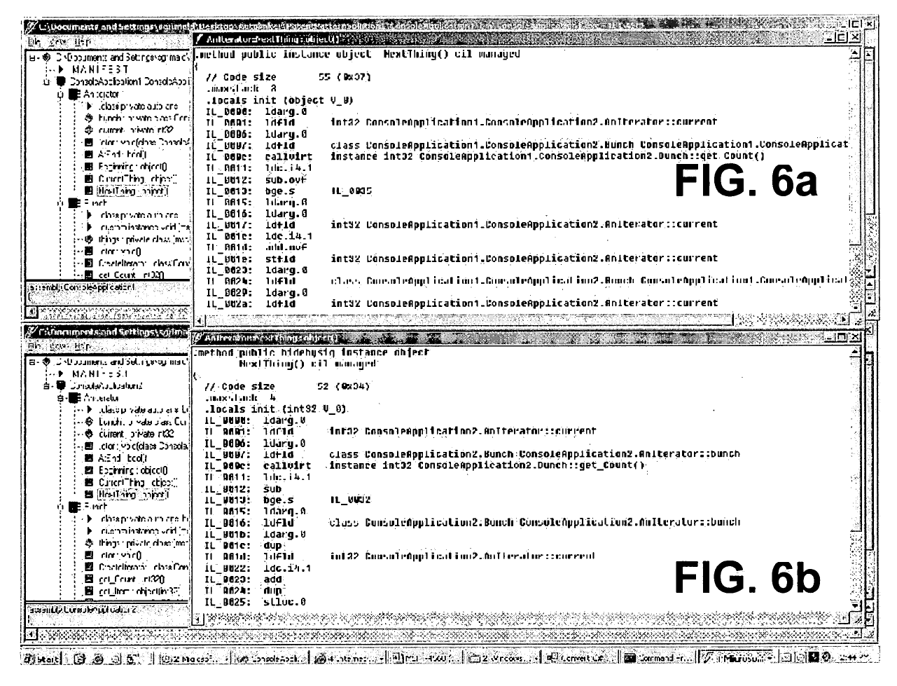

FIGS. 5a and 5b illustrate signatures of disassembled methods in the two programming languages. The similarity of the disassembled code (as illustrated in FIGS. 5a and 5b) is evident. Similarly, the intermediate code produced by the two languages is also almost identical, as illustrated in FIGS. 6a and 6b.

Similarly, Java, C#, and Visual Basic types may also implement the iterator pattern. This can be discovered by analysis of static code, (e.g. source code), or by analysis of runtime behavior. Hence, a common set of documentation available for the iterator pattern can be reused or shared to document code that implements the iterator pattern in other languages.

In a similar way patterns exist in other facets of software: for example, user interfaces exhibit usage patterns. For example, for all products in a suite of programs, a user may be able to use a particular menu item to open a file. The documentation for these usage patterns can be shared, since opening a file in one program and opening a file in a second program require the same user actions.

Identifying patterns may be accomplished in many ways. For example, patterns may be identified by expert developers. Software may analyze the software product to discover patterns implemented in the software and may add attributes to the types/members involved in the implementation. Developers may use attributes to mark code implementing common patterns, accepting or rejecting the generated attributes. Software may flag types and members in the documentation that implement like patterns, based on the attributes, and identify the pattern in the writer's authoring environment. A writer or documenter may then accept the recommendation, so that the text, images, and other media related to that pattern are included in the type/member the writer is documenting.

Alternatively, a subset of software patterns used in the industry may be selected. Software may analyze the target software to discover patterns implemented and may add the types/members to a signature database. Software may flag types and members in the documentation that implement like patterns, based on the signature database. Text, images, and other media related to that pattern may then be included in the documentation. The documentation may receive a final edit by a professional writer.

Similarly, user interface usage patterns may be identified by expert usability engineers, who may analyze the software product to discover usage patterns implemented in the software product and add them to a database. Writers may match these patterns to relevant topics in the documentation. Text, images, and other media related to that pattern may be included in the documentation, which may receive a final edit by a writer.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

What is claimed is:

1. A system for re-using documentation comprising:
a monitor that collects data from a plurality of sources comprising at least a first source and a second source, determines patterns in the collected data, retrieves documentation developed for the first source and applies it to the second source based on common patterns in the collected data.

2. The system of claim 1, wherein the first source is a first computer and a second source is a second computer and the collected data comprises messages sent from the first computer to the second computer.

3. The system of claim 1, wherein the first source is a client computer, the second source is a server computer and the collected data comprises messages sent from the client to the server and messages sent from the server to the client.

4. The system of claim 1, wherein the first source is a first server computer, the second source is a second server computer and a third source is a client computer and the collected data comprise messages sent from the client to the first server computer, messages sent from the client to the second server computer, messages sent from the first server computer to the client and messages sent from the second server to the client.

5. A method for re-using existing documentation developed for a first source to a second source based on a pattern associated with the first source and the second source comprising:
identifying the pattern associated with the first source and the second source;
identifying documentation associated with the first source and applying it to the second source.

6. The method of claim 5, wherein the pattern associated with the first source is stored in a database of patterns and documentation.

7. The method of claim 5, wherein the first source is source code in a first programming language and the second source is source code in a second programming language.

8. The method of claim 5, wherein the pattern comprises a programming construct.

9. The method of claim 5, wherein the pattern comprises a pattern within messages sent from a first computer to a second computer.

10. The method of claim 5, wherein the pattern comprises a series of user actions performed to invoke a feature of an application.

11. The method of claim 5, wherein the pattern comprises a series of user actions performed to execute a feature of an application.

12. A computer-readable medium comprising computer-executable instructions for:
identifying a pattern associated with a first source and a second source, wherein documentation for the pattern associated with the first source is available; and
applying the available documentation for the pattern associated with the first source to the second source.

13. The computer-readable medium of claim 12, comprising further instructions for:
retrieving the available documentation for the first source from a database of patterns and documentation for application to the second source.

14. The computer-readable medium of claim 12, comprising further instructions for:
identifying documentation associated with the first source and applying it to the second source.

15. The computer-readable medium of claim 12, comprising further instructions for:
identifying the pattern associated with the first source and the second source wherein the first source is source code in a first programming language and the second source is source code in a second programming language.

16. The computer-readable medium of claim 12, comprising further instructions for:
identifying the pattern associated with the first source and the second source, wherein the first source and the second source are object code.

17. The computer-readable medium of claim 12, comprising further instructions for:
identifying the pattern associated with the first source and the second source, wherein the first source and the second source are executable code.

18. The computer-readable medium of claim 12, comprising further instructions for:
identifying the pattern associated with the first source and the second source, wherein the first source and the second source are processes.

19. The computer-readable medium of claim 12, comprising further instructions for:
identifying the pattern associated with the first source and the second source, wherein the pattern comprises a series of user actions performed to invoke a feature of an application.

20. The computer-readable medium of claim 12, comprising further instructions for:
identifying the pattern associated with the first source and the second source, wherein the pattern comprises a series of user actions performed to use a feature of an application.
